(19) United States
(12) Patent Application Publication
(10) Pub. No.: US 2006/0059528 A1
(43) Pub. Date: Mar. 16, 2006

(54) Video display system and video display device

(75) Inventors: Yukari Katayama, Chigasaki (JP); Shinya Iguchi, Yokohama (JP); Tsutomu Furuhashi, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD., Tokyo (JP)

(21) Appl. No.: 10/539,750

(22) PCT Filed: Sep. 30, 2003
(86) PCT No.: PCT/JP03/12548

§ 371 Date: Jun. 20, 2005

(30) Foreign Application Priority Data
Jan. 27, 2003 (JP) 2003-016874

(51) Int. Cl. H04N 7/16; H04N 7/18; H04N 7/173

(52) U.S. Cl. 725/114; 725/116; 725/62; 725/80; 725/81

(57) ABSTRACT

A display system provided with transportability and being accessible from a mobile information terminal, a wireless communication network connects between a server 101 and a display device 102 and between the display device 102 and other display devices in tandem. Each display device has an interface for connecting with a mobile information terminal. The communication interface between each display device and the server or another display device uses one protocol for larger-capacity communication at a higher frequency band than that for the wireless communication interface between each display device and a mobile information terminal.

### TECHNICAL FIELD

The present invention relates to a video display system and a video display device, wherein the video display system comprises a video distribution server and a plurality of display devices, each of the server and the display devices has wireless communication functions, and ad-hoc communication is performed between the display devices.

### BACKGROUND ART

In a wide public space such as event site and station and underground passages, a display device with a large display screen has so far been installed to display video images mainly for advertisement or the like. As such a display device shows commercial images to a large number of people at a time, it has a high advertising effectiveness.

A video display system in which a distribution server is connected to a plurality of display devices through wired internet channels has been proposed, for example, a system illustrated in FIG. 3 in Japanese Patent Application Laid-Open No. 2000-105583. The server performs distribution of images (e.g. commercial images) and control of the plurality of display devices connected thereto (e.g. control of image display timing) so that commercial images transmitted from the distribution server are displayed on each of said display devices.

With recent advance of mobile information terminals, a system in which wireless communication is performed between a display device and mobile information terminals has been proposed, for example, in Japanese Patent Application Laid-Open No. 2001-346199. The system is configured such that each of the mobile information terminals can retrieve and download various types of information from the display device by wireless communication.

In station and underground passages and the like, laying wired cables requires huge costs and a long term of work. In an event site, laying wired cables will be expensive because the display system is installed only for a short period, and hiding the cables imposes restrictions on the layout of the event. Then, a system in which a light beam is applied instead of a wired cable for the connection between a server and a display device has been proposed, for example, in Japanese Patent Application Laid-Open No. 2000-22632.

However, in the system using the light beam for the connection, since server and the display device must be located in a range where each side is within the sight of the other, the distance between the server and the display device is limited to the above sight range and blockage of the sight between the server and the display device inhibits the communication therebetween.

### DISCLOSURE OF THE INVENTION

It is an object of the present invention to provide a video display system and a video display device capable of controlling distribution of image information from a video distribution server to a display device in a location where direct communication with the server is disabled because of long distance or blockage between the server and the display device and for other reasons.

It is another object of the present invention to provide a video display system and a video display device that secures smooth communication by suppressing radio interference and avoiding crosstalk of information.

In order to achieve the foregoing objects, in the present invention, the server and a display device are connected through wireless communication and received data are relayed from the display device connected to the server to other display devices one after another so that images can be distributed to display devices far away from the server.

A display device of the present invention has a function to communicate with a user terminal. For the communication between the display device and another display device and the communication between the display device and the user terminal, respective wireless communication protocols having different frequency bands are applied. The communication between display devices uses one communication protocol with larger-capacity at a higher frequency band than that for the communication between the display device and the user terminal.

In the present invention, to ensure sufficient capacity of communication between display devices, each display device is configured so as to perform concurrent communication in two frequency bands. Each display device can communicate with the server or another display device in one frequency band, while communicating with further another display device in the other frequency band.

### BRIEF DESCRIPTION OF THE DRAWINGS

FIG. 1 is a diagram showing a display system of the first embodiment of the present invention.

FIG. 2 is a simplified block diagram of a display device in the system of the first embodiment of the present invention.

FIG. 3 is a diagram showing another configuration of the display system of the first embodiment of the present invention.

FIG. 4 illustrates screen images displayed on a display device and on a mobile information terminal during regular operation in the system of the first embodiment of the present invention.

FIG. 5 illustrates screen images displayed on a display device and on a mobile information terminal during a local guidance service in the system of the first embodiment of the present invention.

FIG. 6 illustrates a coupon downloaded to a mobile information terminal in the system of the first embodiment of the present invention.

FIG. 7 is a flowchart illustrating a processing procedure to be performed by a display device in the system of the first embodiment of the present invention.

FIG. 8 is a flowchart illustrating a processing procedure to be performed by a distribution server in the system of the first embodiment of the present invention.

FIG. 9 is a number table indicating the type of a request to be sent from a display device to the distribution server in the system of the first embodiment of the present invention.

FIG. 10 illustrates a format of data request from a display device to the distribution server in the system of the first embodiment of the present invention.

FIG. 11 is a number table indicating the type of data to be distributed from the image distribution server to a display device in the system of the first embodiment of the present invention.

FIG. 12 illustrates a format of data to be distributed from the server to a display device in the system of the first embodiment of the present invention.

FIG. 13 is a diagram showing a display system of the second embodiment of the present invention.

FIG. 14 is a simplified block diagram of a display device in the system of the second embodiment of the present invention.

### BEST MODE FOR CARRYING OUT THE INVENTION

Description will be made below for embodiments of the present invention by referring to the drawings.

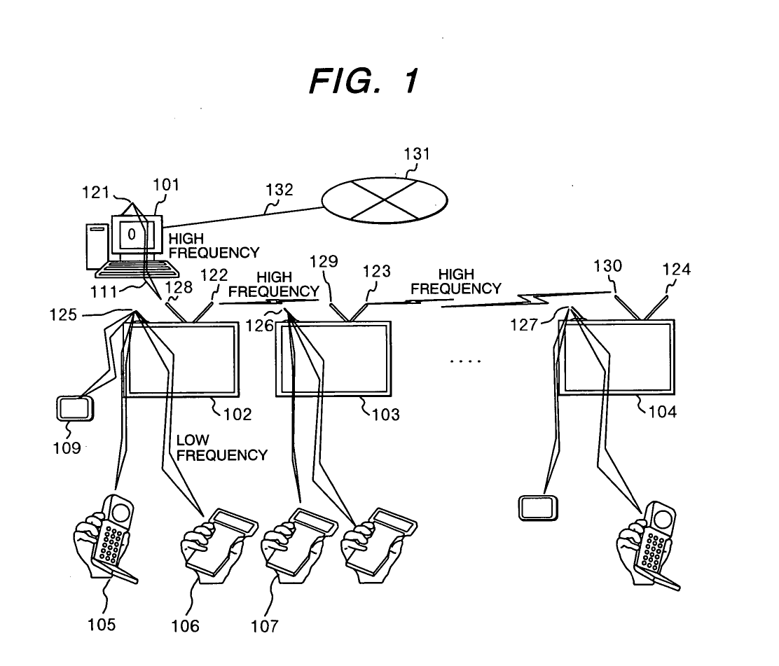

FIG. 1 is a conceptual diagram showing an overall configuration of a video display system as the first embodiment of the present invention. This system is intended to be installed in an event site, a passage in an underground or station building, a department store, etc. to display commercial images and preferably used for a local guide board. This system has a function of distributing service information in association with a commercial image or a local guide board being displayed to mobile information terminals (user terminals) such as Personal Digital Assistants (PDAs) and mobile phones or to apparatuses such as wireless tags and the like, through wireless communication.

Reference numeral 101 denotes a server provided with a function of image data distribution and control and a function of communication with the Internet communication network as a backbone. The server 101 is connected to the Internet communication network 131 by a wired LAN circuit 132. The server 101 is equipped with a communication interface compliant with IEEE 802.11a, which is a standard for wireless communication in a 5 GHz band, and an antenna 121, and communicates with a display device 102 via radio waves 111. The IEEE 802.11a is a standard for high-speed wireless communication having a maximum communication rate of 54 Mbps.

Reference numeral 102 denotes a display device equipped with an antenna 128 for wireless communication with the server 101 and an antenna 122 for wireless communication with another display device 103. Both the antennas 128 and 122 are those for the IEEE 802.11a standard for the wireless communication in the 5 GHz band. The display device 102 is also equipped with an antenna 125 for wireless communication with a mobile phone 105, PDAs 106 and 107, a wireless tag 109, etc. The antenna 125 is compliant with IEEE 802.11b, which is a standard for wireless communication in a 2.4 GHz band. The IEEE 802.11b, for which a maximum communication rate is 11 Mbps, is a standard for wireless communication in a lower frequency and with a smaller capacity than that of the IEEE 802.11a.

The present embodiment will be explained by applying the IEEE 802.11a and IEEE 802.11b to wireless communication standards for different wireless interfaces for explanatory convenience. However, these wireless communication protocols impose no restrictions on the present invention and other wireless communication standards may be applicable. Of course, optical communication or the like is also applicable.

In the present embodiment, an n number of display devices 103 to 104 having the same structure as the display device 102 are connected in tandem by a wireless network. The display devices 103 to 104 have, respectively, two antennas 129 and 123 and two antennas 130 and 124 for wireless communication between display devices and, an antenna 126 and an antenna 127, respectively, for communication with a PDA, mobile phone, wireless tag, etc.

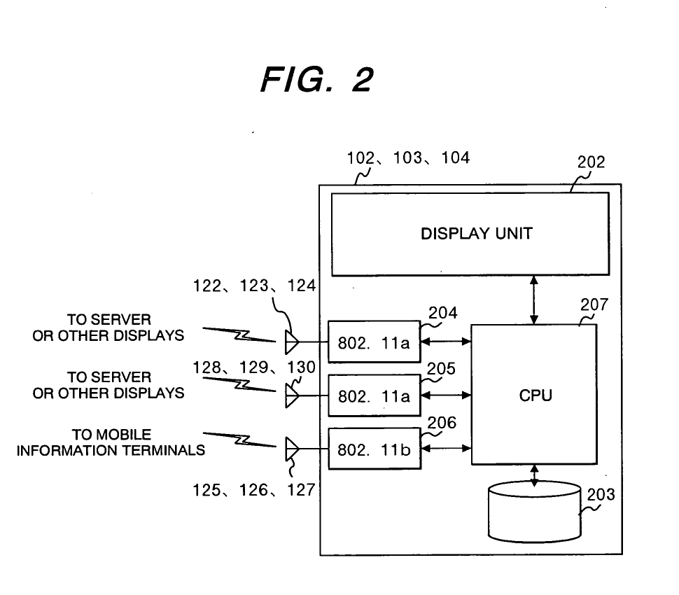

FIG. 2 is a block diagram showing a schematic structure common for the display devices 102, 103 and 104. To simplify explanation, the function of display devices will be described below on a representative display device 103a.

The display device 103 is controlled by a CPU 207. The CPU 207 is connected to a display unit 202, a storage unit 203 such as a hard disk, and communication interfaces 204, 205, and 206. The communication interfaces 204 and 205 perform protocol processing according to the IEEE 802.11a for the wireless communication standard in the 5 GHz band and are connected to the antennas 123 and 129, respectively. The communication interface 206 performs protocol processing according to the IEEE 802.11b for the wireless communication standard in the 2.4 GHz band and is connected to the antenna 126. Namely, the communication interfaces 204 and 205 perform wireless communication with other display devices 102 and 104 at a frequency higher than that of the communication interface 206 for performing wireless communication with a mobile information terminal such as a PDA 106 and a mobile phone 105 or a wireless tag 109.

Here, the communication interface 205 is used for communication with the neighboring display device 102 at upstream side on the wireless network and the communication interface 204 is used for communication with the neighboring display device 104 at downstream side. The communication interfaces 204 and 205 may use different frequencies to each other to suppress radio interference between the display devices.

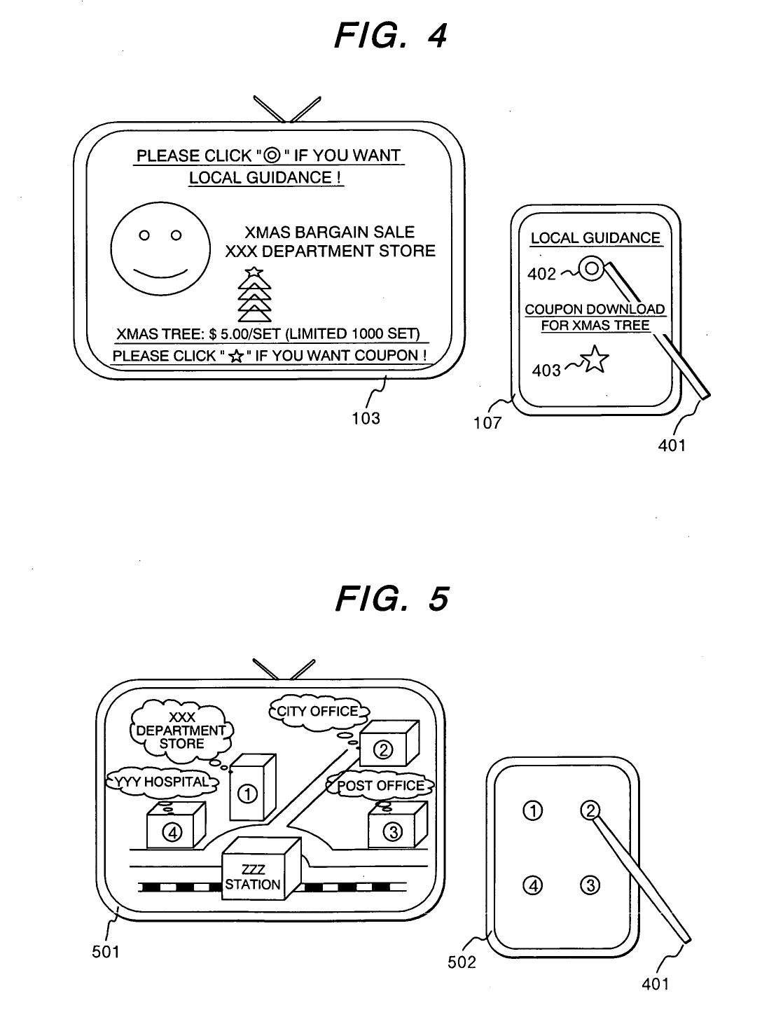

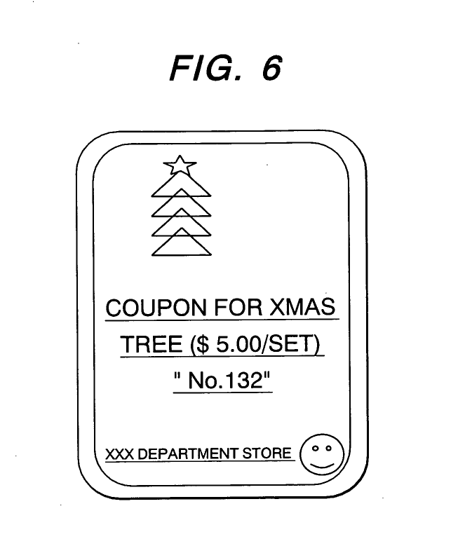

Next, the operation of the video display system of the present invention will be described in brief by referring to FIG. 4 and FIG. 6. In the present video display system, during regular operation, commercial images transmitted from the server are displayed on each display device, like an example screen on the display device 103 illustrated in FIG. 4. When a PDA 107 close to the display device 103 issues a connection request to the display device, the display device 103 transfers image information for a screen associated with the screen being displayed thereon to the PDA 107 so that a screen image as illustrated in FIG. 4 is displayed on the PDA 107. When the user of the PDA 107 clicks, for example, a star mark 403 with a stylus 401 on the commercial image screen in FIG. 4, a coupon illustrated in FIG. 6 will be downloaded from the display device 103 to the PDA 107.

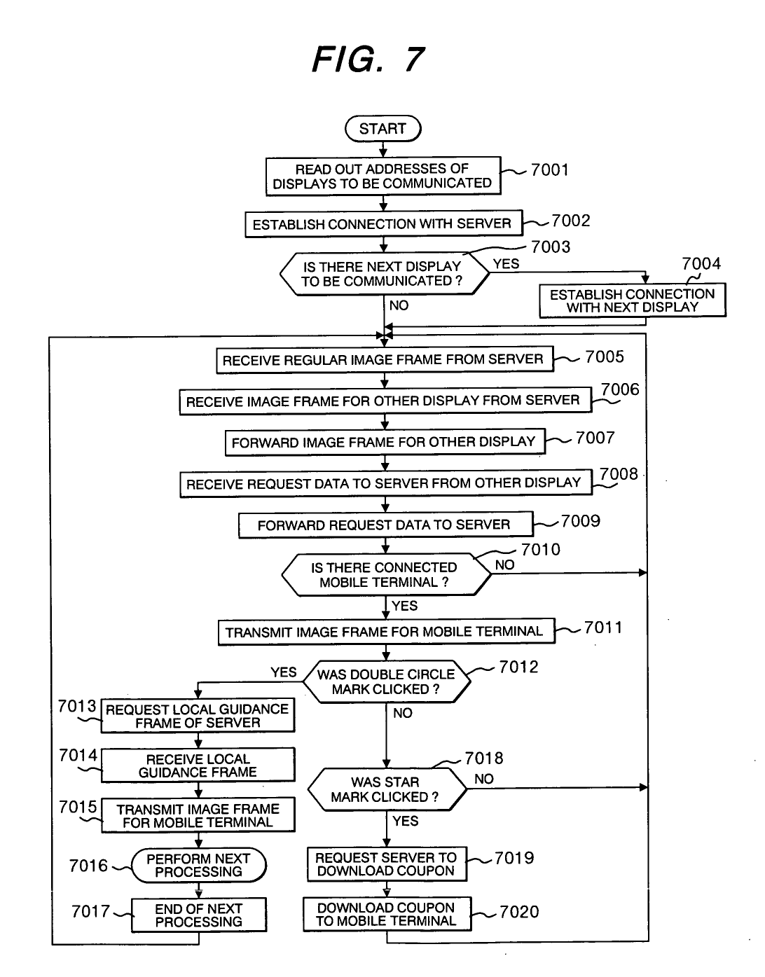

How such a service is implemented concretely in the system of the present invention will be described below by referring to FIGS. 7 through 12.

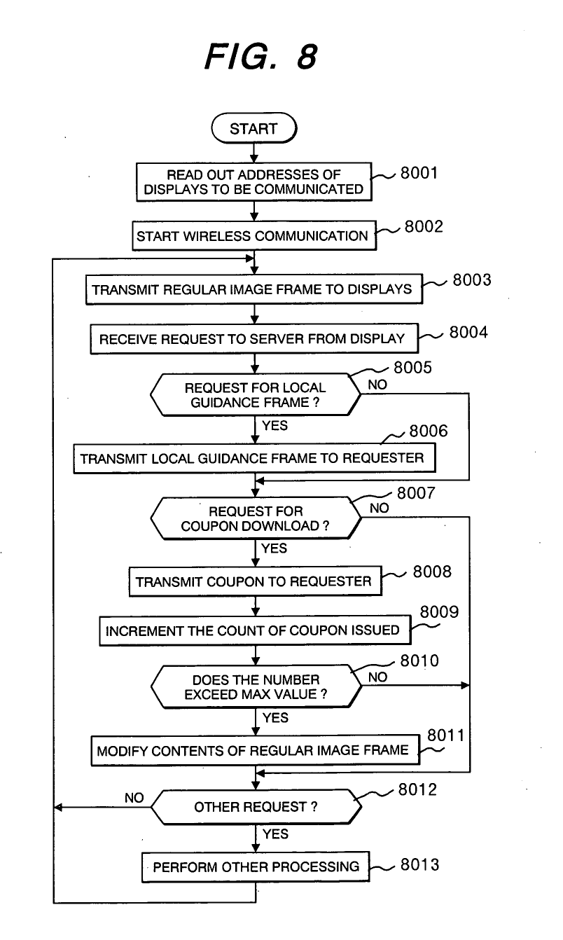

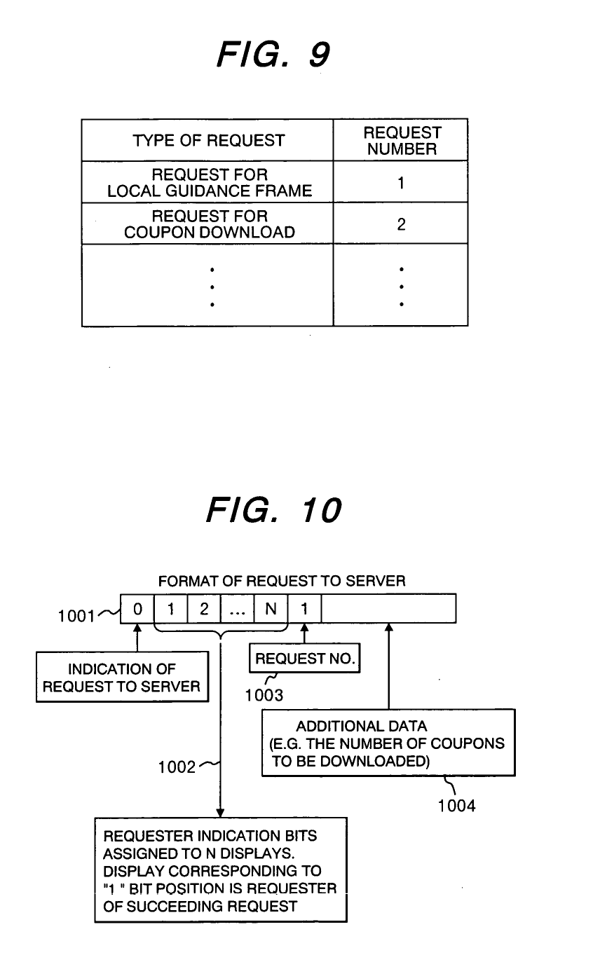

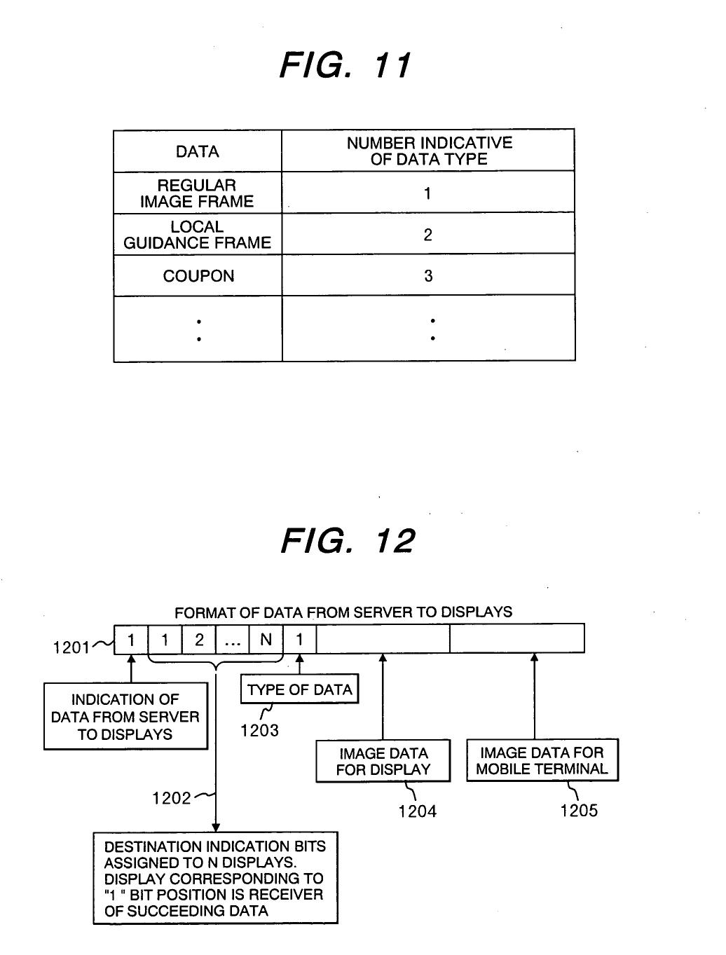

FIG. 7 is a flowchart illustrating operation sequence of the CPU 207 of each of display devices 102, 103 and 104. FIG. 8 is a flowchart illustrating operation sequence of the server 101. FIG. 10 shows a format of a data request message to be used when the display device 103 sends a request for data to the server. FIG. 9 shows the correspondence of a request number to a request type to be specified in the format illustrated in FIG. 10. FIG. 12 shows a format of a data frame to be used when the server 101 transmits image data to each of the display devices 102, 103 and 104. FIG. 11 shows the correspondence of a number indicative of data type to a data content to be specified in the format illustrated in FIG. 12.

As shown in FIG. 8, upon boot-up, the server 101 reads out the address (identifier: ID)) of a display device 102 with which the server should communicate by wireless directly and the addresses of display devices 103 and 104 to be data destinations in the system, as the destination information for image data distribution from a storage unit not shown (step 8001). The server 101 detects a display device 102 to be directly communicated with the server through the antenna 121. If such a display device exists, the server starts wireless communication (step 8002).

First, the server 101 transmits a regular image frame (FIG. 4) in the format illustrated in FIG. 12 to the display device 102 (step 8003). Specifically, a value “1” indicating transmission data from the server to the display device 102 is set in the first block (field) 1201 in a data frame for regular image frame transmission. In a destination indication block 1202, a value “1” is set to each of bits in positions corresponding to the ID numbers of the display devices having been read out as data destinations in step 8001, and a value “0” is set to each of bits in the other positions. A value “1” indicating a regular image frame is set in a data type indication block 1203. Following this block, image data 1204 to be displayed on the display devices and image data 1205 for a mobile information terminal which is in association with the above image data are transmitted.

The image data for a mobile information terminal is not limited to one type; a plurality of types of images may be transmitted according to the number of types of mobile information terminals that are connectable to the display device. The destination information may be transmitted only once when the first connection is established or transmitted repeatedly each time a connection is established. The display device 102 and other display devices store the received destination information into the storage unit 203. Instead, the display device 102 and other display devices may have the destination information previously stored in the storage unit 203 so that they needn't distribution of the destination information from the server 101.

As shown in FIG. 7, the CPU 207 of each display device (102, 103, 104), after booted up, reads out the address of the server 101 or another display device 103 to be directly communicated with the display device, from the storage unit 203 (step 7001) and establishes a connection with the server 101 (step 7002). For example, the CPU 207 of the display device 102 directly communicates with the server 101 through the higher-frequency and larger-capacity communication interface 205 and the antenna 128 and notifies the server of the connection establishment. The CPU 207 of the display device 103 sets up a connection with the upstream display device 102 and notifies the server 101 of the connection establishment for the display device 103 via the display device 102.

The CPU 207 then determines whether there exists any other display device to be directly communicated with the display device 102 from the result of the address reading in step 7001 (step 7003). If there is any display device to be directly communicated with, the CPU 207 establishes a connection with that display device (step 7004) through the communication interface 204 and the antenna 122 (123, 124). After establishing the connection with the display device 103, the display device 102 notifies the server 101 that the display device 103 was connected. Upon receiving a notification of the connection with the display device 104 from the downstream display device 103, for example, the display device 102 notifies the server 101 that the display device 104 was connected. In this manner, in order of the display devices 102, 103, . . . 104, the connections with neighboring display devices are sequentially notified to the server 101 via one or more intermediate display devices.

Next, the display device 102 (103, 104) receives a image data frame of the regular screen distributed from the server 101 through the antenna 128 (129, 130) and the communication interface 205 (step 7005). Because the image data frame distributed from server 101 has the format as sown in FIG. 12, the CPU 207 checks the destination indication block 1202 of the received frame. If a value “1” is set to a bit in the position corresponding to the ID number of the display device (for example, the first bit in the block 1202 for the display device 102; the second bit in the block 1202 for the display device 103), the CPU judges that it is the image data to be received by itself and stores the image data into the storage unit 203. At this time, both the image 1204 for display devices and the image 1205 for a mobile information terminal are stored into the storage unit 203. In fact, the server 101 distributes the image data to be displayed on the mobile information terminal as well as the image data to be displayed on the display device 102. The CPU 207 of each display device outputs the image 1204 for display devices out of the image data stored in the storage unit 203 to the display unit 202. Then, the CPU 207 transmits the received image data frame to the next display device (the display device 103 in the case where the display device 102 has received the image data frame) located downstream through the communication interface 204 and the antenna 122 (123, 124).

Focusing on the display device 102, subsequent operations will be described below. When the server 101 distributes image data to another display device 103 located downstream of the display device 102, the CPU 207 of the display device 102 receives the image data through the communication interface 205 (step 7006). In this case, because the image data received is not for the display device 102, the CPU 207 forwards the received image data frame as it is to the next downstream display device 103 through the communication interface 204 without storing the received image data into the storage unit 203 (step 7007). However, the CPU 207 of the display device 102 may once store the image data to be forwarded to the downstream display device 103 into the storage unit 203, so that the CPU 207 reads out the image data to be forwarded to the display device 103 from the storage unit, forwards that data to the display device 103, and removes the image data which has become unnecessary from the storage unit 203.

Upon receiving a request data issued from another display device 103 to the server 101 through the communication interface 204 (step 7008), the CPU 207 forwards the request data to the server through the communication interface 205 (step 7009). The CPU 207 checks whether a connection with a mobile information terminal exists (step 7010). If there is no connection with a mobile information terminal, the program sequence returns to step 7005 to wait for the next image data that will be distributed from the server 101 or request data issued from the other display device 103 or 104.

If a connection setup with a PDA 106 is detected in step 7010, the CPU 207 transmits the image 1205 for a mobile information terminal, associated with the regular image frame, stored in the storage unit 203 to the PDA 106 through the low-frequency-band communication interface 206 (step 7011). As the result of the above operations, the screens shown in FIG. 4 are displayed on the display device and the mobile communication terminal, respectively.

When the user of the PDA 106 clicks a double circle mark 402 with the stylus 401, local guidance service images 501 and 502, for example, shown in FIG. 5 are presented. When a local guidance service image 501 is displayed on the display device 103, the display on the PDA also automatically switches to an image 502 associated with the local guidance service image 501. On the PDA 106, numbers corresponding to large buildings included in a local guide map displayed on the display device 103 are shown, for example, as illustrated in FIG. 5. When the user clicks a number corresponding to any building with the stylus 401, the PDA screen changes to a screen showing the details of that building.

Since the display size (resolution) of the mobile information terminal is smaller than that of the display device 103, it is preferable that the server 101 reduces the size of the image to be displayed on the mobile information terminal smaller than that of the image to be displayed on the display device 103 before distributing the image data frame. When an image having the same contents as that displayed on the display device 103 is required to be displayed on the mobile information terminal, it may also be preferable that the CPU 207 of the display device 103 transmits an image obtained by automatically resizing (for example, scaling down) the image displayed on the display device 10 to the mobile information terminal. If the image displayed on the display device 103 is a video image, whereas the image displayed on the mobile information terminal is a still image, it may also be preferable that the CPU 207 of the display device 103 extracts a still image from the video image displayed on the display device 103, and resizes the still image to transmit it to the mobile information terminal. It may also be preferable that the CPU 207 identifies an image being displayed on the display unit 202 when the mobile information terminal was connected to the display device and retrieves an image for the mobile information terminal, associated with the identified image, from the storage unit 203.

As described above, when the user of the PDA 106 clicks the double circle mark 402 with the stylus 401, a control message indicting that the double circle mark has been clicked is transmitted from the PDA 106 to the display device 102 via the antenna 126 and the message is forwarded to the CPU 207 through the low-frequency communication interface 206.

Upon detecting that the double circle mark 402 has been clicked on the PDA 106 (step 7012), the CPU 207 issues to the server 101 a request for a local guidance frame in the format illustrated in FIG. 10 (step 7013). In a block 1001 in the request for a local guide frame, a value “0” is set. In a requester indication block 1002, a value “1” is set to only the first bit corresponding to the ID number “1” of the display device 102 and a value “0” is set to each of the other bits (second to Nth bits). In a request number block 1003, a value “1” indicating the local guidance frame (see FIG. 9) is set. The request for the local guidance frame is transmitted to the server 101 through the larger-capacity communication interface 205 for the higher frequency band.

As illustrated in FIG. 8, upon receiving the request message (request data) from the display device 102 (step 8004), the server 101 checks the value contained in the block 1003 in the request message. If the request message is the request for the local guidance frame (step 8005), the server 101 transmits the local guidance frame in the frame format illustrated in FIG. 12 (step 8006). In particular, in the data frame of the local guidance, a value “1” is set in the block 1201. In the destination indication block 1202, a value “1” is set to only the first bit corresponding to the ID number of the requester display device 102 and a value “0” is set to each of the other second to Nth bits. In the block 1203, a value “2” indicating the local guidance frame is set. With this data frame, for example, the image 501 shown in FIG. 5 is transmitted as the image 1204 for display devices and the image 502 shown in FIG. 5 is transmitted as the image 1205 for a mobile information terminal. The local guidance frame is transmitted from the server 101 to the display device 102 through the larger-capacity communication interface 205 for the higher frequency band.

Upon receiving the image data from the server 101 through the communication interface 205 (step 7014), the CPU 207 of the display device 102 checks the values contained in the destination indication block 1202. In this example, since only the first bit is “1” and each of the other bits is “0”, it is recognized that the received image data should be received by the display device 102 only. Further, since the data type indication block 1203 includes a value “2”, it is recognized that the received data represents the local guidance frame. In this case, after storing the received image data (the image 1204 for display devices and the image 1205 for a mobile information terminal) into the storage unit 203, the CPU 207 displays the image 1204 for display devices on the display unit 202 and forwards the image 1205 for a mobile information terminal to the mobile communication terminal through the communication interface 206 (step 7015).

As the result of the above operations, the screens shown in FIG. 5 are displayed on the display device and the mobile communication terminal, respectively. When the user of the mobile communication terminal clicks any of encircles numbers 1, 2, 3, and 4 on the screen with the stylus 401, detailed information about the building displayed on the display device 102 which is corresponding to the number clicked can be obtained. To simplify explanation, in FIG. 7, the CPU 207 executes a detailed information service (processing from sending a request for detailed information to the server to displaying a detailed information screen) in response to the click operation by the mobile communication terminal user in step 7016. When the detailed information service terminated, the CPU 207 requests the server to transmit the regular image frame shown in FIG. 4 (step 7017) and the program sequence returns to step 7005. When the user of the mobile communication terminal clicks the star mark 403 with the stylus 401 on the regular screen shown in FIG. 4, a control message indicating that the star mark 403 has been clicked is transmitted from the PDA 106 to the display device 102 via the antenna 126. The control message is forwarded to the CPU 207 of the display device 102 through the low-frequency communication interface 206.

Upon detecting that the star mark 403 has been clicked on the PDA 106 (step 7018), the CPU 207 issues to the server 101 a request to download a coupon in the format shown in FIG. 10 (step 7019). In the coupon download request, a value “0” is set in the block 1001. In the requester indication block 1002, a value “1” is set to only the first bit corresponding to the display device 102 and a value “0” is set to each of the second to Nth bits corresponding to other display devices. In the request number bock 1003, a value “2” indicating the coupon download request (see FIG. 9) is set. In the block 1004, a value “m” indicating the number of coupons to be downloaded is set. In the case where the display device 102 is requested to download a coupon from a plurality of mobile information terminals, the value m in the block 1004 becomes m>1. The coupon download request message is transmitted to the server 101 through the larger-capacity communication interface 205 for the higher frequency band.

As illustrated in FIG. 8, upon receiving the above request message from the display device 102 (step 8004), the server 101 recognizes, from the value in the request number block 1003, that the received request message is the coupon download request (step 8007) and transmits to the requester display device the coupon image in the format shown in FIG. 12 (step 8008). In the coupon image download frame, in particular, a value “1” is set in the block 1201. In the destination indication block 1202, a value “1” is set to only the first bit corresponding to the display device 102 and a value “0” is set to each of the second to Nth bits corresponding to other display devices. A value “3” indicating a coupon is set to the data type indication block 1203. In this case, only the coupon image shown in FIG. 6 is transmitted as the image 1205 for a mobile information terminal without transmission of the image 1204 for display devices. This coupon image is transmitted to the display device 102 through the larger-capacity communication interface 205 for the higher frequency band.

After transmitting the coupon image data, the server 101 increments the count of coupons by adding the number “m” of coupons requested in the block 1004 of the above request data to the number of coupons issued so far (step 8009). When the count exceeds a predetermined maximum value (step 8010), the regular screen is altered to a screen which announces that the coupon download service has been terminated (step 8011). If a request received from the display device is the above request for the local guidance frame or the coupon request, the program sequence returns to step 8003. If the received request is any request other than the request for the local guidance frame or the coupon request (step 8012), other processing corresponding to the request is performed (step 8013) before returning to step 8003. Inconsequence, the regular image frame is distributed to the display device 102 (103, 104). When the download service has been terminated, a regular screen updated in step 8011 is displayed on the display devices.

Upon receiving the coupon image data from the server through the communication interface 205, since a value “1” is set to the first bit only and each of the second to Nth bits includes a value “0” in the destination indication block 1202, the CPU 207 of the display device 102 can recognize that the received data should be received by the display device 102 only. Also, it can recognize that the received data is a coupon image download frame, as a value “3” is set to the data type block 1203. In this case, after storing the received image data into the storage unit 203, the CPU 207 forwards the image 1205 for a mobile information terminal to the mobile information terminal through the communication interface 206 (coupon download: 7020). Then, the screen shown in FIG. 6 is displayed on the mobile information terminal.

In the foregoing, the operation of the system according to the first embodiment of the present invention has been described.

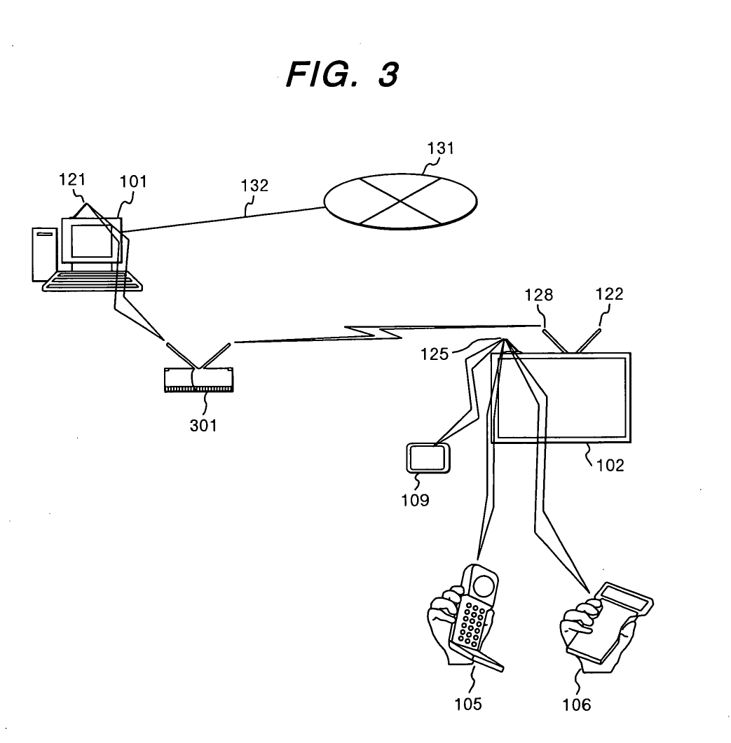

In the first embodiment, it is desirable to apply a large-capacity communication channel to the connection between the server and the display device 102 and between the display device 102 and the display device 103, and so on, in order to transfer a large amount of data such as download data to be distributed to PDAs and data to be displayed on each of display devices 102, 103, 104. In the first embodiment, it is not always necessary to directly connect the server 101 and the display device 102 by a wireless network. For instance, a wireless repeater 301 to relay signals may exist between the display device 102 and the server 121, as is shown in FIG. 3. A network configuration in which the server 101 and the display device 102 are connected by a wired network and the display device 102, the next display device 103, and subsequent display devices are connected in tandem by a wireless network may also be applicable.

According to the above-described network configuration of the first embodiment of the present invention, the server 101 and the display device 102 are directly connected, but the server 101 is not needed to be directly connected with any other display device, e.g., with the display device 104 by a wireless communication. Thus, images can be distributed to even the display device 104 installed far away from the server 101 beyond the coverage of radio waves from the server 101. Even if blockage exists between the server 101 and the display device 104, images can be distributed to the display device 104 by adjusting the locations of other display devices for relaying image data and control information, which are installed between the server 101 and the display device 104.

If there exist a plurality of display devices to which video services should be provided, at downstream side of the display device 102 connected to the server 101, different radio frequencies may be used for each downstream display device. In this case, each of the display devices requires to have a communication interface corresponding to a frequency that is used by its neighboring downstream display device. Therefore, for example, each display device may be equipped with a plurality of communication interfaces different in frequency so that the CPU 207 of the display device can select a communication interface compatible with the downstream display device when the display device establishes communication with the downstream display device.

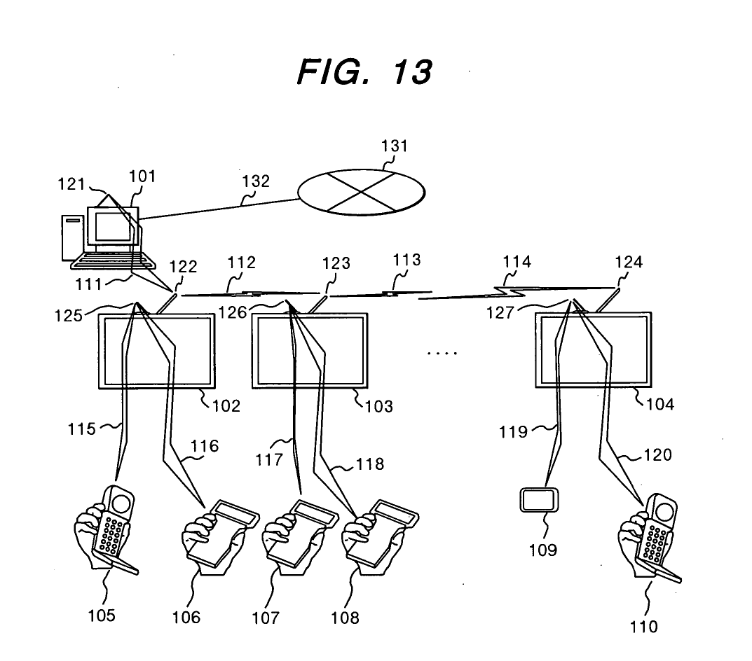

FIG. 13 shows a system configuration in the second embodiment of the present invention.

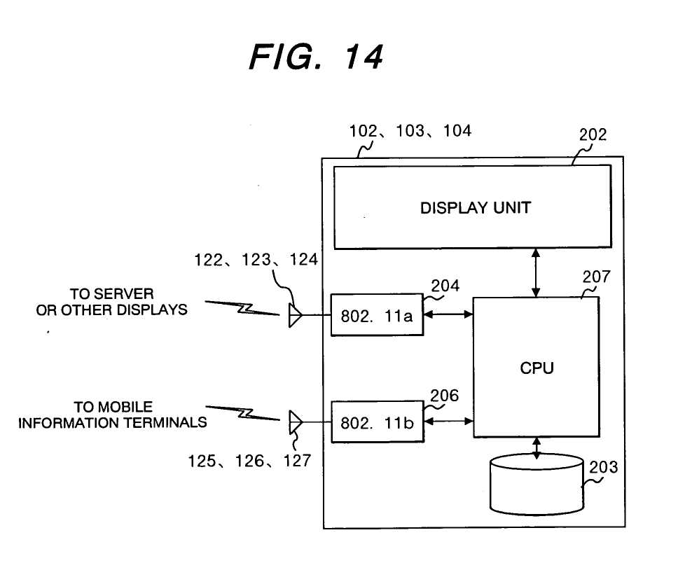

The second embodiment differs from the first embodiment in that each display device performs wireless communication with the server 101 or another display device through an single antenna. A block diagram of a schematic structure common to the display devices 102, 103, 104 in the second embodiment is shown in FIG. 14.

A display device in the second embodiment is equipped with an IEEE 802.11a interface 204 and an IEEE 802.11b interface 206. The display device 102 that directly communicates with the server 101 performs communication with the server 101 and communication with another display device 103, by switching in terms of time (in a time division manner). Other display devices 103 and 104 also perform communication with the upstream display device and communication with the downstream display device in a time division manner. This communication manner differs from the first embodiment.

It will be appreciated that the present invention is not limited to the embodiments described above, can be modified without departing from its spirit or essential characteristics, and carried out regardless of the field of application.

According to the present invention, because one display device is connected to the video distribution server and all display devices are connected in tandem by a wireless communication network and the display device connected to the video distribution server functions as the first relay node and controls distribution of images to other display devices, the system has a feature of prominently great transportability.

According to the present invention, by connecting a plurality of display devices in tandem with a wireless communication protocol, images can be distributed to a display device located at a long distance away from the video distribution server or to a display device located in a direction in which direct communication with the video distribution server is disabled by the presence of blockage.

According to the present invention, each display device is provided with a function of wireless communication with mobile information terminals and performs communication with the server or another display device and communication with a mobile information terminal, using wireless communication protocols different in frequency band. The communication with the server or another display device involving transfer of a large amount of data is performed by a protocol for larger-capacity wireless communication at higher frequency than that of another protocol applied to the communication with a mobile information terminal for which the amount of data to be transferred is relatively small. Consequently, smooth communication avoiding crosstalk of information can be carried out. Furthermore, according to the present invention, by providing each display device with a function of concurrent wireless communication in two frequency bands so that each display device can communicate with the server or another display device in one frequency band, while communicating with another display device in the other frequency band, a great capacity of communication between display devices can be ensured.

### INDUSTRIAL APPLICABILITY

The present invention is useful in an instance where images distributed from a video distribution server are displayed on a plurality of display devices.

1-14. (canceled)

15. A video display system comprising a server for distributing images and a plurality of display devices capable of communicating with each other,
each of said display devices comprising:
a first communication interface for bidirectional communication with said server or another display device located at upstream side on a image distribution path;
a second communication interface for bidirectional communication with one of the other display devices located at downstream side on the image distribution path;
a third communication interface for bidirectional communication with a user terminal;
a storage unit for storing images received from said server or said another display device at upstream side;
a display unit for displaying said received images; and
a processing unit coupled to said first, second and third communication interfaces, said storage unit and said display unit,
said user terminal comprising:
a communication interface for bidirectional communication with said display devices;
a display unit smaller in size than that of the display device; and
an input unit for accepting input from a user,
wherein each of said display devices receives an image from said server or said another display device at upstream side through said first communication interface, transmits the received image to said one of the other display devices at downstream side through said second communication interface according to a request from said server or said one of the other display devices at downstream side, and transmits the received image to said user terminal through said third communication interface according to a request from the user terminal.

16. The video display system according to claim 15, wherein a communication frequency between said server and the first communication interface of each of said display devices is higher than a communication frequency between the second communication interface of each of said display devices and the communication interface of said user terminal.

17. A video displaying system comprising a plurality of display devices capable of communicating with each other,
each of said display devices comprising:
a first communication interface for bidirectional communication with one of the other display devices of the plurality of said display devices;
a second communication interface for bidirectional communication with a user terminal;
a storage unit for storing images;
a display unit for displaying an image; and
a processing unit coupled to said first and second communication interfaces, said storage unit and said display unit,
wherein said processing unit performs, through said first communication interface in time division manner, receiving processing of an image distributed from another display device located at upstream side on a image distribution path and forwarding processing of the received image to one of the other display devices located at downstream side on the image distribution path,
said user terminal comprising:
a communication interface for bidirectional communication with said display devices;
a display unit smaller in size than that of the display device; and
an input unit for accepting input from a user,
wherein a communication frequency between the first communication interfaces of said display devices is higher than a communication frequency between the second communication interface of each of said display devices and the communication interface of said user terminal.

18. A video displaying system comprising a server for distributing images and a plurality of display devices capable of communicating with each other,
each of said display devices comprising:
a first communication interface for bidirectional communication with said server or a first one the plurality of said display devices;
a second communication interface for bidirectional communication with a second one of the plurality of said display devices;
a storage unit for storing images received from said server or said first one of said display devices;
a display unit for displaying said received images; and
a processing unit coupled to said first and second communication interfaces, said storage unit and said display unit,
wherein said processing unit stores images received from said first communication interface into said storage unit, and forward the received images to the second one of said display devices through said second communicating interfaces,
wherein a communication frequency between the first communication interface of each of said display devices and said server or the first one of said display deices is different from a communication frequency between the second communication interface of each of said display devices and the second one of said display devices.

19. A video display device for bidirectional communication with a image distribution server or other video display devices, comprising:
an image storage unit;
an image display unit;
a first communication interface for communicating with said server or other video display devices;
a second communication interface for communicating with a user terminal; and
a processing unit for storing images transmitted from said server or said another video display device and received through said first communication interface into said storage unit and forwarding images read out from said storage unit to said display unit,
said user terminal comprising:
a communication interface for bidirectional communication with the video display device;
a display unit smaller in size than that of the video display device; and
an input unit for accepting input from a user,
wherein a communication frequency for said first communication interface is higher than that for said second communication interface.

20. The video display device according to claim 19, wherein:
said first communication interface comprises a third communication interface capable of communication with said server or another video display device located at upstream side along a distribution path of said images, and a fourth communication interface for transmitting said images to one of other video display devices located at downstream side along the distribution path of said images,
said storage unit stores an identifier of said downstream side video display device, and
said processing unit establishes communication with said downstream side video display device through said fourth interface according to the identifier stored in said storage unit.

21. The video display device according to claim 20, wherein:
said images are received together with an identifier of a destination video display device, and
said processing unit compares its own identifier and the identifier of said destination video display device, transmits images including an identifier not matching with its own identifier to said downstream side video display device through said fourth interface, and removes the images including the identifier not matching with its own identifier from said storage unit.

22. The video display device according to claim 19, wherein:
said first communication interface comprises a third communication interface for communication with said server or another video display device located at upstream side along a distribution path of said images, and a fourth communication interface for communication with one of the other video display devices located at downstream side along the distribution path of said images, and
a frequency for said third communication interface is different from that for said fourth communication interface.

23. The video display device according to claim 19, wherein:
said first communication interface receives a first image to be displayed on said display unit and a second image to be displayed on said user terminal from said server or said another video display device, and
upon receiving a request from said user terminal through said second communication interface, said processing unit identifies a second image received together with the first image which was displayed on said display unit at a point of time when the request was received, and transmits the identified second image to said user terminal through said second communication interface.

24. The video display device according to claim 23, wherein the contents of said second image are related to the contents of said first image.

25. The video display device according to claim 19, wherein:
when said second communication interface receives a request from said user terminal, said processing unit scales down the image being displayed on said display unit at a point of time when the request has been received from said user terminal, and transmits the image scaled down to said user terminal through said second communication interface.

26. A video display device for displaying images received from a server for distributing images or another video display device located at upstream side along a distribution path of said images and transmitting the received images to one of other video display devices located at downstream side along the distribution path of said images, comprising:
a first communication interface for receiving, from said server or said another video display device at upstream side, destination information including an identifier of a destination video display device specified by said server;
a second communication interface for requesting the surrounding other video display devices to send their device identifiers and receiving response information indicating identifiers of video display devices in operation; and
a determination unit which compares the identifier indicated in said destination information received through said first communication interface and the device identifiers indicated in said response information received through said second communication interface, and decides a video display device in operation, which has a device identifier matched with the identifier indicated in said destination information, as a destination of the received image.

27. The video display device according to claim 26, wherein:
said second communication interface establishes communication with said downstream video display device, and
when said second communication interface has established communication with said downstream video display device, said first communication interface notifies said server or said upstream video display device of communication established between the video display device and the downstream video display device.

28. The video display device according to claim 26, further comprising a third communication interface for communication with a user terminal.
